(19) United States
(12) Patent Application Publication
(10) Pub. No.: US 2022/0251413 A1
(43) Pub. Date: Aug. 11, 2022

(54) LOW TEMPERATURE CURING OF WATERBORNE COATINGS

(71) Applicant: BASF Coatings GmbH, Münster (DE)

(72) Inventors: Gajanan Joshi, Pune (IN); Chintankumar Jayantilal Patel, Ludwigshafen (DE); Prasad Am Ramanna, Mangalore (IN); Kevin Turley, Southfield, MI (US); Paragkumar Thanki, Mangalore (IN); Qingling Zhang, Southfield, MI (US); Rajesh Rathod, Vadodara (IN)

(21) Appl. No.: 17/417,825

(22) PCT Filed: Dec. 12, 2019
(86) PCT No.: PCT/EP2019/084850

§ 371 Date: Jun. 24, 2021

(30) Foreign Application Priority Data
Dec. 24, 2018 (EP) 18215818.8

(51) Int. Cl. C09D 175/04

(52) U.S. Cl. CPC C09D 175/04

(57) ABSTRACT

Described herein is an aqueous basecoat composition. Also described herein are a method of coating a substrate and use of the aqueous basecoat composition for improving the performance properties of basecoat materials.

### CROSS-REFERENCE TO RELATED APPLICATIONS

This application is a U.S. National Phase Application of International Patent Application No. PCT/EP2019/084850, filed Dec. 12, 2019, which claims priority to European Patent Application No. 18215818.8, filed Dec. 24, 2018, the entire contents of which are hereby incorporated by reference herein.

### TECHNICAL FIELD

The present subject matter relates to an aqueous basecoat composition. The present subject matter particularly relates to a method of coating a substrate and use of the aqueous basecoat composition to improve the performance properties of basecoat materials and coatings produced using the basecoat composition.

### BACKGROUND

Waterborne coating compositions are in demand in the automotive refinish market due to increasingly strict environmental regulations. There is also demand for OEM basecoat from the line for the repairs. Traditionally, in the OEM market, it is ensured that there is proper color match on the repairs and small quantities of special low bake basecoats for all colors sprayed in the plant is prevented. A commercially acceptable waterborne coating composition for the automotive refinish market or the OEM market must satisfy certain requirements. The waterborne coating compositions must cure at ambient temperatures or slightly higher and demonstrate good pot life, water resistance, adhesion and hardness. The

OEM basecoats known already from the line do not cure to provide sufficient properties at low temperatures such as in the range of 80° C. to 140° C. Conventionally, two-component isocyanate clearcoat compositions are known and described in the prior art to address this problem. But these compositions in repairs are typically sprayed by hand in an open shop and can be harmful. Hence coating compositions without live isocyanate are required.

In order to improve the performance properties of waterborne coating compositions, carbodiimide crosslinkers have been included in the compositions. In the state of the art, solventborne coating compositions and waterborne coating compositions having carbodiimide crosslinkers or acid catalysts are known and described, for instance, in the following references.

EP 0610533 A1 discloses a two-package coating composition as a clearcoat for the multilayer coating of articles, comprising an (A) (a1) acrylic resin, (a2) additives, (B) (b1) a polycarbodiimide, (b2) optionally a crosslinker selected from the group consisting of polyisocyanates, aminoplasts, and mixtures thereof; and (b3) additives.

EP 1539894 B1 discloses waterborne coating compositions comprising at least one base neutralized active hydrogen containing film-forming resin and a water dispersible carbodiimide crosslinker.

EP 0709415 B1 discloses a curable basecoat composition comprising a resin component, a curing agent, a Lewis acid catalyst and a pigment.

U.S. Pat. No. 6,084,038 A discloses a curable coating composition comprising a compound having at least one carbamate group or terminal urea group and having a lactone or hydroxy carboxylic acid moiety, a polymer resin and curing agent.

U.S. Pat. No. 6,239, 212 B1 discloses a curable coating composition comprising a carbamate functional material, a crosslinking agent and a hydroxyl functional polysiloxane component.

U.S. Pat. No. 8,981, 005 B2 discloses coating compositions comprising polycarbodiimides having onium salt groups and a film forming resin that is different from the polycarbodiimide.

WO 2018/022788 A1 discloses acid catalysed coating compositions comprising a polymeric resin, an acid curing catalyst and a 1,1-di-activated vinyl compound.

US 2016/0175886 A1 discloses a multicoat colour and/or effect paint system comprising at least one first basecoat comprising a basecoat material, wherein the basecoat material comprises at least one binder, at least one colour or effect pigment and at least one water-soluble or water-dispersible, corrosion-inhibiting, oligomeric or polymeric component.

The methods and compositions disclosed in the prior arts have limitations. The compositions described in the prior arts described above do not provide coating compositions that can be cured at low temperatures to protect heat-sensitive components. In an automotive OEM application, there are heat-sensitive components of the final assembly that needs to be repaired even after the vehicle is fully assembled. The standard waterborne basecoat compositions disclosed in the prior arts will not be able to cure sufficiently and perform at lower temperatures to provide required film properties. The OEM basecoats known in the prior art are generally used along with two-component isocyanate clearcoat that can be hazardous and harmful while spraying. Since, the demand for automotive OEM market is increasing, there is a need for an improved coating composition that can overcome the above-mentioned drawbacks and provide low temperature curing.

Hence, it is an object of the presently claimed invention to provide an aqueous basecoat composition that can be cured at low temperature, preferably at temperatures in the range of ≥80° C. to ≤140° C., and in addition provides improved film properties such as hardness, sandability/polishability and adhesion.

A further object of the presently claimed invention is to provide a process for coating comprising curing the applied coating layer at low temperatures, preferably at temperatures in the range of ≥80° C. to ≤140° C.

### SUMMARY

Surprisingly, it was found that the coating compositions comprising at least one acid curing catalyst and at least one polycarbodiimide as described hereinbelow provide improved physical film properties such as hardness, sandability/polishability and adhesion. Further, it was unexpectedly found that the process for coating a substrate with the coating compositions as described hereinbelow is more efficient and enables curing at low temperatures in the range of ≥80° C. to ≤140 ° C.

Accordingly, in one aspect, the presently claimed invention is directed to an aqueous basecoat composition comprising:

(A) (i) at least one active hydrogen containing film-forming resin; and
(ii) at least one crosslinker selected from the group consisting of aminoplast resins and blocked polyisocyanates;

(B) at least one acid curing catalyst; and

(C) at least one polycarbodiimide.

In another aspect, the presently claimed invention is directed to a process for coating a substrate comprising the steps of:

(i) applying a coating layer over at least a portion of the substrate, the coating layer comprising:

(A) (a) at least active hydrogen film-forming resin; and
(b) at least one crosslinker selected from the group consisting of aminoplast resins and blocked polyisocyanates;

(B) at least one acid curing catalyst; and

(C) at least one polycarbodiimide; and

(ii) curing the applied coating layer at a temperature ≥80° C. to ≤140 ° C.

In yet another aspect, the presently claimed invention is directed to the use of an aqueous basecoat composition as described hereinbelow in automotive finishing, industrial coating, repair coating, paint and wood coating.

In another aspect, the presently claimed invention is directed to an article which is coated with an aqueous basecoat composition described hereinbelow.

The presently claimed invention is associated with at least one of the following advantages:

(i) The aqueous basecoat composition of the presently claimed invention can cure sufficiently at low temperatures in the range of ≥80° C. to ≤140 ° C.

(ii) The aqueous basecoat composition of the presently claimed invention provides improved physical film properties such as hardness, sandability/polishability and adhesion.

(iii) The aqueous basecoat composition can be sprayed over a sanded OEM body panel, as part of a repair layering even along with a repair clearcoat.

(iv) The aqueous basecoat composition can be used in conjunction with a live-isocyanate free clearcoat in an open shop to achieve the physical film properties such as hardness, sandability/polishability and adhesion at temperatures that were previously unattainable. In doing so, the workers are protected from any exposure to isocyanates.

Other objects, advantages and applications of the presently claimed invention will become apparent to those skilled in the art from the following detailed description.

### DETAILED DESCRIPTION

The following detailed description is merely exemplary in nature and is not intended to limit the presently claimed invention or the application and uses of the presently claimed invention. Furthermore, there is no intention to be bound by any theory presented in the preceding technical field, background, summary or the following detailed description.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the subject matter described herein are capable of operation in other sequences than described or illustrated herein. In case the terms “(A)”, “(B)” and “(C)” or “(a)”, “(b)”, “(c)”, “(d)”, “(i)”, “(ii)” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the subject matter are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” or “preferred embodiment” means that a particular feature, structure or characteristic described in connection with the embodiment is included in at least one embodiment of the presently claimed invention. Thus, appearances of the phrases “in one embodiment” or “in an embodiment” or “in a preferred embodiment” in various places throughout this specification are not necessarily all referring to the same embodiment but may refer. Furthermore, the features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the subject matter, and form different embodiments, as would be understood by those in the art. For example, in the appended claims, any of the claimed embodiments can be used in any combination.

Furthermore, the ranges defined throughout the specification include the end values as well, i.e. a range of 1 to 10 implies that both 1 and 10 are included in the range. For the avoidance of doubt, the applicant shall be entitled to any equivalents according to applicable law.

Reference throughout this specification for compound names starting with ‘poly’ designate substances, which formally contain per molecule, two or more of the functional groups. The compound itself can be monomeric, oligomeric or polymeric compound. For instance, a polyol is a compound having two or more hydroxy groups, a polyisocyanate is a compound having two or more isocyanate groups.

For the purposes of the presently claimed invention, the mass-average (Mw) and number-average (Mn) molecular weight is determined by means of gel permeation chromatography at 40° C., using a high-performance liquid chromatography pump and a refractive index detector. The eluent used was tetrahydrofuran with an elution rate of 1 ml/min. The calibration is carried out by means of polystyrene standards.

For the purposes of the presently claimed invention, the acid number indicates the amount of potassium hydroxide, in milligrams, which is needed to neutralize 1 g of the respective constituent. For the purposes of the presently claimed invention, unless otherwise indicated, the acid number is determined experimentally by titration in accordance with DIN EN ISO 2114.

For the purposes of the presently claimed invention, the equivalent weight indicates or is equal to mass of the substance in grams that would react with or replace one gram of hydrogen and is expressed as the ratio of atomic weight or molecular weight to the valence.

For the purposes of the presently claimed invention, the pKa value is determined in water by potentiometric titration. In a potentiometric titration, a known volume of reagent is added stepwise to a solution of analyte. The change in potential upon reaction is consequently measured with the use of two electrodes, an indicator, and a reference electrode. These are often integrated in a combined pH electrode. Plotting the potential versus volume subsequently gives rise to a sigmoid curve, where the inflection point gives the potential at equilibrium. With the use of standards with known pH, this potential can be linearly converted into a pH, equalling pKa. The pKa value is calculated using Henderson-Hasselbalch equation provided hereinbelow that relates pH and pKa to the equilibrium concentrations of dissociated acid [A−] and non-dissociated acid [HA] respectively:

For the purposes of the presently claimed invention, the term “aqueous” is defined as a system which comprises a significant fraction of water as the main dispersion medium besides organic solvents. The term “aqueous “can be interchangeably used with the term “waterborne. “For the purposes of the presently claimed invention, a waterborne coating composition is a composition that comprises water as a main solvent.

For the purposes of the presently claimed invention, a basecoat or a basecoat film is generally a layer containing the colour or pigment component.

For the purposes of the presently claimed invention, a clearcoat or clearcoat film is a layer that provides gloss, smoothness and surface stability including weather resistance, as well as mar and scratch resistance.

For the purposes of the presently claimed invention, the term “curing” denotes the heat-initiated crosslinking of a coating film, with either self-crosslinking binders or else a separate crosslinking agent, in combination with a polymer as binder, (external crosslinking), being used in the parent coating material.

For the purposes of the presently claimed invention, a binder or a solid binder is the non-volatile component of the aqueous basecoat composition of the presently claimed invention, without the pigments and the fillers.

For the purposes of the presently claimed invention, a pigment is defined to be any substance that alters the colour of a material through selective absorption or any substance that scatters and reflects light.

For the purposes of the presently claimed invention, effect pigments are defined as flake or platy structures that impart a directional light reflectance, scattering, absorption, or optically variable appearance to the substrate in or on which they are applied.

For the purposes of the presently claimed invention, ‘% by weight’ or ‘wt. % ’ as used in the presently claimed invention is with respect to the total weight of the coating composition. Further, sum of wt.-% of all the compounds, as described hereinbelow, in the respective component adds up to 100 wt.-%.

The above-mentioned measurement techniques are well known to a person skilled in the art and therefore do not limit the presently claimed invention.

An aspect of the presently claimed invention describes an aqueous basecoat composition comprising:

(A) (i) at least one active hydrogen containing film-forming resin; and
(ii) at least one crosslinker selected from the group consisting of aminoplast resins and blocked polyisocyanates;

(B) at least one acid curing catalyst; and

(C) at least one polycarbodiimide.

### Component (A)

The aqueous basecoat composition of the presently claimed invention comprises (i) at least one active hydrogen containing film-forming resin; and (ii) at least one crosslinker selected from the group consisting of aminoplast resins and blocked polyisocyanates that together constitute component (A).

In a preferred embodiment of the presently claimed invention, the at least one active hydrogen containing film-forming resin of component (A) is selected from the group consisting of polyurethane, polyacrylate, polyester-polyurethane hybrid polymers, polyurethane-polyacrylate hybrid polymers, polyester-polyurethane-polyacrylate hybrid polymers, polyesters, polyethers, polyester polyols and polysiloxane. In another preferred embodiment of the presently claimed invention, the at least one active hydrogen containing film-forming resin of component (A) is selected from mixtures of different of polymers selected from the group consisting of polyurethane, polyacrylate, polyester-polyurethane hybrid polymers, polyurethane-polyacrylate hybrid polymers, polyester-polyurethane-polyacrylate hybrid polymers, polyesters, polyethers, polyester polyols and polysiloxane.

In a more preferred embodiment of the presently claimed invention, the at least one active hydrogen containing film-forming resin of component (A) is selected from the group consisting of polyesters, polyethers, polyester-polyurethane hybrid polymers, polyurethane-polyacrylate hybrid polymers, and polyester-polyurethane-polyacrylate hybrid polymers.

In another preferred embodiment of the presently claimed invention, the at least one active hydrogen film-forming resin of component (A) has a weight average molecular weight in the range of ≥1,000 g/mol to ≤100,000 g/mol determined according to gel permeation chromatography against a polystyrene standard. In a more preferred embodiment of the presently claimed invention, the at least one active hydrogen film-forming resin of component (A) has a weight average molecular weight in the range of ≥30,000 g/mol to ≤50,000 g/mol determined according to gel permeation chromatography against a polystyrene standard.

In yet another preferred embodiment of the presently claimed invention, the at least one active hydrogen film-forming resin of component (A) has an acid value in the range of ≥5 mg KOH/g to ≤100 mg KOH/g, determined according to ASTM D4662.

In another preferred embodiment of the presently claimed invention, the at least one active hydrogen film-forming resin of component (A) is present in an amount in the range of ≥10 wt. % to ≤40 wt. %, based on the total weight of the aqueous basecoat composition. In a more preferred embodiment of the presently claimed invention, the at least one active hydrogen film-forming resin of component (A) is present in an amount in the range of ≥20 wt. % to ≤35 wt. %, based on the total weight of the aqueous basecoat composition.

The aqueous basecoat composition of the presently claimed invention comprises at least one crosslinker selected from the group consisting of aminoplast resins and blocked polyisocyanates.

In a preferred embodiment of the presently claimed invention, the at least one crosslinker of component (A) is selected from aminoplast resins, more preferably the at least one crosslinker of component (A) is a melamine resin.

In a preferred embodiment of the presently claimed invention, the at least one crosslinker of component (A) is selected from blocked polyisocyanates, more preferably the at least one crosslinker of component (A) is selected from polyisocyanates selected from the group consisting of trimethylene diisocyanate, tetramethylene diisocyanate, pentamethylene diisocyanate, hexamethylene diisocyanate, propylene diisocyanate, ethylethylene diisocyanate, 2,3-dimethylethylene diisocyanate, 1-methyltrimethylene diisocyanate, 1,3-cyclopentylene diisocyanate, 1,4-cyclohexylene diisocyanate, 1,2-cyclohexylene diisocyanate, 1,3-phenylene diisocyanate, 1,4-phenylene diisocyanate, 2,4-toluylene diisocyanate, 2,6-toluylene diisocyanate, 4,4-diphenylene diisocyanate, 4,4′-methylene bisdiphenyldiisocyanate, 1,5-naphthylene diisocyanate, 1,4-naphthylene diisocyanate, 1-isocyanatomethyl -3-isocyanato-3,5,5-trimethylcyclohexane, isophorone diisocyanate or IPDI, 1,3-bis(1-isocyanato-1-methylethyl)benzene, m-tetramethylxylene diisocyanate or TMXDI, bis(4-isocyanatocyclohexyl)methane, bis(4-isocyanatophenyl)methane, 4,4′-diisocyanatodiphenyl ether and 2,3-bis(8-isocyanatooctyl)-4-octyl-5-hexylcyclohexane.

In a more preferred embodiment of the presently claimed invention, the at least one crosslinker of component (A) is selected from hexamethylene diisocyanate, IPDI, and TMXDI. It is also possible to use polyisocyanates of higher isocyanate functionality. Representative examples of polyisocyanates of higher isocyanate functionality include but are not limited to tris(4-isocyanatophenyl)methane, 1,3,5-triisocyanatobenzene, 2,4,6-triisocyanatotoluene, 1,3,5-tris(6-isocyanatohexylbiuret), bis(2,5-diisocyanato-4-methyl phenyl) methane, 1,3,5-tris (6-isocyanatohexyl)-1,3,5-triazinane-2,4,6-trione (i.e., hexamethylene diisocyanate cyclic trimer), 1,3,5-tris(6-isocyanatohexyl) and polymeric polyisocyanates, such as dimers and trimers of diisocyanatotoluene. It is further also possible to use mixtures of polyisocyanates. The isocyanates for use as the crosslinker in the presently claimed invention can also be prepolymers which are derived for example from a polyol, including a polyether polyol or a polyester polyol.

In yet another preferred embodiment of the presently claimed invention, the at least one crosslinker of component (A) is present in an amount in the range of ≥5 wt. % to ≤45 wt. %, based on the total weight of the aqueous basecoat composition. In a more preferred embodiment of the presently claimed invention, the at least one crosslinker of component (A) is present in an amount in the range of ≥20 wt. % to ≤40 wt. %, based on the total weight of the aqueous basecoat composition.

### Component (B)

The aqueous basecoat composition of the presently claimed invention comprises at least one acid curing catalyst as component (B). In a preferred embodiment of the presently claimed invention, the at least one acid curing catalyst component (B) comprises a strong acid.

In another preferred embodiment of the presently claimed invention, the strong acid has a pKa value of ≤1.5 in water at 25° C. In a more preferred embodiment of the presently claimed invention, the strong acid has a pKa value of ≤1.0 in water at 25° C. In yet another preferred embodiment of the presently claimed invention, the strong acid is selected from the group consisting of organic acids. In a preferred embodiment of the presently claimed invention, the organic acid is a sulfonic acid or a phosphonic acid.

In a preferred embodiment of the presently claimed invention, the sulfonic acid is selected from the group consisting of para-toluenesulfonic acid (p-TSA), benzenesulfonic acid, methanesulfonic acid, dodecylbenzenesulfonic acid, dinonylnaphthalene sulfonic acid and dinonylnaphthalene disulfonic acid.

In another preferred embodiment of the presently claimed invention, the phosphonic acid is selected from the group consisting of butyl acid phosphate, phenyl acid phosphate and 2-ethylhexyl acid phosphate.

In yet another preferred embodiment of the presently claimed invention, the strong acid is blocked with at least one amine. In another preferred embodiment of the presently claimed invention, the at least one amine is selected from the group consisting of aminomethyl propanol, dimethyl oxazolidine, diisopropanolamine, dimethylethanolamine, pyridine, triethylamine, dimethylamino methyl propanol, dimethyloxazolidine, aminomethylpropanol and diisopropanolamine.

In another preferred embodiment of the presently claimed invention, the at least one acid curing catalyst is a blocked sulfonic acid.

In yet another preferred embodiment of the presently claimed invention, the at least one acid curing catalyst is present in an amount in the range of ≥0.1 wt. % to ≤5 wt. %, based on the total weight of the aqueous basecoat composition. In a more preferred embodiment of the presently claimed invention, the at least one acid curing catalyst is present in an amount in the range of ≥0.5 wt. % to ≤2.5 wt. %, based on the total weight of the aqueous basecoat composition.

### Component (C)

The aqueous basecoat composition of the presently claimed invention comprises at least one polycarbodiimide as component (C).

In a preferred embodiment of the presently claimed invention, the at least one polycarbodiimide has a carbodiimide equivalent weight in the range of 100 g/mol to 600 g/mol. In a more preferred embodiment of the presently claimed invention, the at least one polycarbodiimide has a carbodiimide equivalent weight in the range of 250 g/mol to 450 g/mol. In a most preferred embodiment of the presently claimed invention, the at least one polycarbodiimide has a carbodiimide equivalent weight in the range of 300 g/mol to 450 g/mol.

In another preferred embodiment of the presently claimed invention, the at least one polycarbodiimide is present in an amount in the range of ≥0.1 wt. % to ≤10 wt. %, based on the total weight of the aqueous basecoat composition. In a more preferred embodiment of the presently claimed invention, the at least one polycarbodiimide is present in an amount in the range of 0.5≥wt. % to ≤5 wt.%, based on the total weight of the aqueous basecoat composition.

### Additives

The aqueous basecoat composition of the presently claimed invention further comprises additives. For the purposes of the presently claimed invention, representative examples of additives include but are not limited to binders, paints, dyes, plasticizers, flame retardants, diluents, solvents, fillers, wetting agent, UV-stabilizers, antioxidants, flow agents, rheology control agent and light stabilizers. In a preferred embodiment of the presently claimed invention, the additives are selected from the group consisting of solvents, binders, fillers, wetting agent, UV-stabilizers, antioxidants, flow agents, rheology control agent and light stabilizers. For the purposes of the presently claimed invention, the at least one binder is preferably selected from the group consisting of poly(meth)acrylates, polystyrenics, polyesters, alkyds, polysaccharides and polyurethanes.

### Stabilizers

Stabilizers are used to prevent degradation and protect against aging and weathering. For the purposes of the presently claimed invention, representative examples of stabilizers are preferably primary and secondary antioxidants, hindered amine light stabilizers, UV absorbers, hydrolysis control agents and quenchers. An example of a primary antioxidant is Irganox® from BASF. It suppresses the formation of free radical species and hydroperoxides in polyols both during storage and conversion. An example of UV absorber is Tinuvin®, from BASF. An example of hindered amine light stabilizers is Chimassorb® from BASF. Examples of commercial stabilizers are provided in Plastics Additive Handbook, 5th Edition, H. Zweifel, ed., Hanser Publishers, Munich, 2001 ([1]), p.98 S136. Suitable stabilizers are silane compounds such as Cycloquart® from BASF. Wetting and dispersing agent

A wetting agent or a dispersing agent is either a non-surface-active substance or a surface-active substance added to improve the separation of particles and to prevent settling or clumping. For the purposes of the presently claimed invention, representative examples of wetting and dispersing agents are preferably salts of unsaturated polyamine amides and low-molecular acidic polyesters and mixtures thereof, for example antiterra® U, disperbyk®, Byk® 088 from BYK Chemie.

### Flame Retardant

A flame retardant is a chemical substance that is added to both reduce the likelihood of the finished product catching fire and slow down combustion. For the purposes of the presently claimed invention, representative examples of flame retardants preferably include, but not limited to, tricresyl phosphate, tris(2-chloroethyl) phosphate, tris(2-chloropropyl) phosphate, tris(1,3-dichloropropyl) phosphate, tris(2,3-dibromo¬propyl) phosphate and tetrakis(2-chloroethyl) ethylene diphosphate.

### Filler

For the purposes of the presently claimed invention, fillers preferably include but not to limited to the customary, familiar organic and inorganic fillers, reinforcing agents and weighting agents. Representative examples of inorganic fillers are silicatic minerals, for example sheet-silicates such as antigorite, serpentine, hornblendes, amphibols, chrisotile, talc; metal oxides, such as kaolin, aluminium oxides, aluminium silicate, titanium oxides and iron oxides, metal salts such as chalk, barite and inorganic pigments, such as cadmium sulfide, zinc sulfide and also glass particles. Representative examples of organic fillers include but not limited to carbon black, melamine, expandable graphite, rosin, cyclopentadienyl resins, graft polymers, cellulose fibres, polyester fibres based on aromatic and/or aliphatic dicarboxylic esters and carbon fibres. The inorganic and organic fillers can be used individually or as mixtures.

### Diluent

For the purposes of the presently claimed invention, the diluent is preferably an organic solvent. Representative examples of suitable organic solvents are preferably naphthalenes, mineral spirits or alcohols, low molecular mass diols, such as alkylene glycols and dimethylolcyclohexane.

### Rheology Modifiers

Rheology modifiers are preferably used to control the flow properties of the coating compositions during storage, transportation, processing, application, and post-application to a particular surface. For the purposes of the presently claimed invention, representative examples of rheology modifiers preferably include, but not limited to, modified and unmodified organic clays, and a large variety of organic compounds.

In a preferred embodiment of the presently claimed invention, the additives are present in an amount in the range of ≥0.1 wt. % to ≤10 wt. %, based on the total weight of the aqueous basecoat composition. In a more preferred embodiment of the presently claimed invention, the additives are present in an amount in the range of ≥0.5 wt. % to ≤5 wt. %, based on the total weight of the aqueous basecoat composition.

In a preferred embodiment of the presently claimed invention, the aqueous basecoat composition of the presently claimed invention further comprises an amine in free form. In another preferred embodiment of the presently claimed invention, the amine in free form is selected from the group consisting of alkylamines, alkanolamines and ammonia. In a preferred embodiment of the presently claimed invention, the amine in free form is selected from ammonia, monoethanolamine, ethylamine, dimethylamine, diethylamine, triethylamine, propylamine, dipropylamine, isopropylamine, diisopropylamine, triethanolamine, butylamine, dibutylamine, 2-ethylhexylamine, ethylenediamine propylenediamine, ethylethanolamine, dimethylethanolamine, diethylethanolamine, 2-amino-2-methylpropanol, and morpholine.

In a preferred embodiment of the presently claimed invention, the amine in the free form is present in an amount in the range of ≥0.01 wt. % to ≤10 wt. %, based on the total weight of the aqueous basecoat composition. In a more preferred embodiment of the presently claimed invention, the amine in the free form is present in an amount in the range of 0.05≥wt. % to ≤5 wt. %, based on the total weight of the aqueous basecoat composition.

In a preferred embodiment of the presently claimed invention, the molar ratio of the at least one amine and at least one amine in free form to the at least one active hydrogen film-forming resin is in the range of 1.5:1 to 3.5:1. In a more preferred embodiment of the presently claimed invention, the molar ratio of the at least one amine and at least one amine in free form to the at least one active hydrogen film-forming resin is in the range of ≥2:1 to ≤3:1.

In a preferred embodiment of the presently claimed invention, the aqueous basecoat composition comprises at least one pigment.

For the purposes of the presently claimed invention, the at least one pigment is a virtually insoluble, finely dispersed, organic or inorganic colorant as per the definition in the German standard specification DIN 55944.

In a preferred embodiment of the presently claimed invention, the at least one pigment is selected from the group consisting of organic pigments and metallic pigments.

Representative examples of at least one pigment include but are not limited to organic pigments, colour pigments, metallic pigments and effect pigments. The colour pigments and the effect pigments are known to one skilled in the art and are described, for example, in Rompp-Lexikon Lacke and Druckfarben, Georg Thieme Verlag, Stuttgart, N.Y., 1998, pages 176 and 451. The terms “colouring pigment” and “colour pigment” are interchangeable, just like the terms “visual effect pigment” and “effect pigment”.

Representative examples of organic pigments include but are not limited to, monoazo pigments, such as C.I. Pigment Brown 25; C.I. Pigment Orange 5, 13, 36 and 67; C.I. Pigment Red 1, 2, 3, 5, 8, 9, 12, 17, 22, 23, 31, 48:1, 48:2, 48:3, 48:4, 49, 49:1, 52:1, 52:2, 53, 53:1, 53:3, 57:1, 63, 112, 146, 170, 184, 210, 245 and 251; C.I. Pigment Yellow 1, 3, 73, 74, 65, 97, 151 and 183; disazo pigments, such as C.I. Pigment Orange 16, 34 and 44; C.I. Pigment Red 144, 166, 214 and 242; C.I. Pigment Yellow 12, 13, 14, 16, 17, 81, 83, 106, 113, 126, 127, 155, 174, 176 and 188; anthanthrone pigments, such as C.I. Pigment Red 168 (C.I. Vat Orange 3);anthraquinone pigments, such as C.I. Pigment Yellow 147 and 177; C.I. Pigment Violet 31; anthraquinone pigments, such as C.I. Pigment Yellow 147 and 177; C.I. Pigment Violet 31; anthrapyrimidine pigments: C.I. Pigment Yellow 108 (C.I. Vat Yellow 20); quinacridone pigments, such as C.I. Pigment Red 122, 202 and 206; C.I. Pigment Violet 19; quinophthalone pigments, such as C.I. Pigment Yellow 138; dioxazine pigments, such as C.I. Pigment Violet 23 and 37; flavanthrone pigments, such as C.I. Pigment Yellow 24 (C.I. Vat Yellow 1); indanthrone pigments, such as C.I. Pigment Blue 60 (C.I. Vat Blue 4) and 64 (C.I. Vat Blue 6); isoindoline pigments, such as C.I. Pigment Orange 69; C.I. Pigment Red 260; C.I. Pigment Yellow 139 and 185; isoindolinone pigments, such as C.I. Pigment Orange 61; C.I. Pigment Red 257 and 260; C.I. Pigment Yellow 109, 110, 173 and 185; isoviolanthrone pigments, such as C.I. Pigment Violet 31 (C.I. Vat Violet 1); metal complex pigments, such as C.I. Pigment Yellow 117, 150 and 153; C.I. Pigment Green 8; perinone pigments, such as C.I. Pigment Orange 43 (C.I. Vat Orange 7); C.I. Pigment Red 194 (C.I. Vat Red 15); perylene pigments, such as C.I. Pigment Black 31 and 32; C.I. Pigment Red 123, 149, 178, 179 (C.I. Vat Red 23), 190 (C.I. Vat Red 29) and 224; C.I. Pigment Violet 29; phthalocyanine pigments, such as C.I. Pigment Blue 15, 15:1, 15:2, 15:3, 15:4, 15:6 and 16; C.I. Pigment Green 7 and 36; pyranthrone pigments, such as C.I. Pigment Orange 51; C.I. Pigment Red 216 (C.I. Vat Orange 4); thioindigo pigments, such as C.I. Pigment Red 88 and 181 (C.I. Vat Red 1); C.I. Pigment Violet 38 (C.I. Vat Violet 3); triarylcarbonium pigments, such as C.I. Pigment Blue 1, 61 and 62; C.I. Pigment Green 1; C.I. Pigment Red 81, 81:1 and 169; C.I. Pigment Violet 1, 2, 3 and 27; C.I. Pigment Black 1 (aniline black); C.I. Pigment Yellow 101 (aldazine yellow), and C.I. Pigment Brown 22.

Representative examples of effect pigments include, but are not limited to, platelet-shaped metal effect pigments such as lamellar aluminum pigments, gold bronzes, oxidized bronzes and/or iron oxide-aluminum pigments, pearlescent pigments such as pearl essence, basic lead carbonate, bismuth oxide chloride and/or metal oxide-mica pigments and/or other effect pigments such as platelet-shaped graphite, platelet-shaped iron oxide, multilayer effect pigments composed of PVD films and/or liquid crystal polymer pigments. Particularly preferred for use at any rate, although not necessarily exclusively, are platelet-shaped metal effect pigments, more particularly plated-shaped aluminum pigments.

Representative examples of colour pigments include, but are not limited to, inorganic colouring pigments such as white pigments such as titanium dioxide, zinc white, zinc sulfide or lithopone; black pigments such as carbon black, iron manganese black, or spinel black; chromatic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chromium orange; or yellow iron oxide, nickel titanium yellow, chromium titanium yellow, cadmium sulfide, cadmium zinc sulfide, chromium yellow or bismuth vanadate.

For the purposes of the presently claimed invention, the at least one pigment can also comprise mixtures of two or more different pigments.

The solids content of the aqueous basecoat composition of the presently claimed invention may vary according to the requirements of the case in hand. The solids content is guided primarily by the viscosity that is needed for application, more particularly spray application. The solids content of the aqueous basecoat composition of the presently claimed invention is preferably at least 20 wt. %, more preferably at least 30 wt. %, most preferably in the range of ≥20 wt. % to ≤50 wt. %.

In a preferred embodiment of the presently claimed invention, an aqueous basecoat composition is provided comprising the following components:

(A) (i) at least one active hydrogen containing film-forming resin; and
(ii) at least one crosslinker selected from the group consisting of melamine and blocked polyisocyanates;

(B) at least one acid curing catalyst selected from sulfonic acid or a phosphonic acid; and

(C) at least one polycarbodiimide.

In a preferred embodiment of the presently claimed invention, an aqueous basecoat composition is provided comprising the following components:

(A) (i) at least one active hydrogen containing film-forming resin; and
(ii) at least one crosslinker selected from the group consisting of melamine and blocked polyisocyanates;

(B) at least one acid curing catalyst with pKa value of ≤1.5 in water at 25° C.; and

(C) at least one polycarbodiimide.

In another preferred embodiment of the presently claimed invention, an aqueous basecoat composition is provided comprising the following components:

(A) (i) at least one active hydrogen containing film-forming resin selected from the group consisting of polyesters, polyethers, polyester-polyurethane hybrid polymers, polyurethane-polyacrylate hybrid polymers, and polyester-polyurethane-polyacrylate hybrid polymers; and
(ii) at least one crosslinker selected from the group consisting of melamine and blocked polyisocyanates;

(B) at least one blocked sulfonic acid; and

(C) at least one polycarbodiimide.

In another preferred embodiment of the presently claimed invention, an aqueous basecoat composition is provided comprising the following components:

(A) (i) at least one active hydrogen containing film-forming resin selected from the group consisting of polyesters, polyethers, polyester-polyurethane hybrid polymers, polyurethane-polyacrylate hybrid polymers, and polyester-polyurethane-polyacrylate hybrid polymers; and
(ii) at least one melamine;

(B) at least one blocked sulfonic acid; and

(C) at least one polycarbodiimide.

In another preferred embodiment of the presently claimed invention, an aqueous basecoat composition is provided comprising the following components:

(A) (i) at least one active hydrogen containing film-forming resin selected from the group consisting of polyesters, polyethers, polyester-polyurethane hybrid polymers, polyurethane-polyacrylate hybrid polymers, and polyester-polyurethane-polyacrylate hybrid polymers; and
(ii) at least one crosslinker selected from the group consisting of melamine and blocked polyisocyanates;

(B) at least one amine blocked acid curing catalyst; and

(C) at least one polycarbodiimide.

In yet another embodiment of the presently claimed invention describes an aqueous basecoat composition comprising:

(A) (i) at least one active hydrogen containing film-forming resin; and
(ii) at least one crosslinker selected from the group consisting of aminoplast resins and blocked polyisocyanates;

(B) at least one acid curing catalyst;

(C) at least one polycarbodiimide; and

(D) at least one neutralizing agent.

In an embodiment of the presently claimed invention, the at least one neutralizing agent is an amine.

In yet another preferred embodiment of the presently claimed invention, an aqueous basecoat composition is provided comprising the following components:

(A) (i) at least one active hydrogen containing film-forming resin; and
(ii) at least one crosslinker selected from the group consisting of melamine and blocked polyisocyanates;

(B) at least one amine blocked acid curing catalyst;

(C) at least one polycarbodiimide; and

(D) at least one amine in free form selected from the group consisting of alkylamines, alkanolamines and ammonia.

In another preferred embodiment of the presently claimed invention, an aqueous basecoat composition is provided comprising the following components:

(A) (i) at least one active hydrogen containing film-forming resin; and
(ii) at least one crosslinker selected from the group consisting of melamine and blocked polyisocyanates;

(B) at least one blocked sulfonic acid;

(C) at least one polycarbodiimide; and

(D) at least one amine in free form selected from the group consisting of alkylamines and alkanolamines.

For purposes of the presently claimed invention, the aqueous basecoat composition is preferably produced by mixing of the components described hereinabove. The mixing may take place by means of mixers known to a skilled person. Representative examples of mixers include but not limited to, stirred containers, dissolvers, bead mills, roll mills, static mixers either batch-wise or continuously.

In another aspect, the presently claimed invention is directed to process for coating a substrate comprising the steps of:

applying a coating layer over at least a portion of the substrate, the coating layer comprising:

(A) (a) at least active hydrogen film-forming resin; and
(b) at least one crosslinker selected from the group consisting of aminoplast resins and blocked polyisocyanates;

(B) at least one acid curing catalyst; and

(C) at least one polycarbodiimide; and

curing the applied coating layer at a temperature ≥80° C. to ≤140° C.

In a preferred embodiment of the presently claimed invention, the applied coating layer is cured at a temperature ≥80° C. to ≤110° C.

In another preferred embodiment of the presently claimed invention, a process for coating a substrate is provided comprising the steps of:

applying a coating layer over at least a portion of the substrate, the coating layer comprising:

(A) (a) at least active hydrogen film-forming resin; and
(b) at least one crosslinker selected from the group consisting of aminoplast resins and blocked polyisocyanates;

(B) at least one acid curing catalyst; and

(C) at least one polycarbodiimide; and

curing the applied coating layer at a temperature ≥80° C. to ≤110° C.

In another preferred embodiment of the presently claimed invention, a process for coating a substrate is provided comprising the steps of:

applying a coating layer over at least a portion of the substrate, the coating layer comprising:
(A) (a) at least active hydrogen film-forming resin; and
   (b) at least one crosslinker selected from the group consisting of melamine and blocked polyisocyanates;
(B) at least one blocked sulfonic or blocked phosphonic acid; and
(C) at least one polycarbodiimide; and

curing the applied coating layer at a temperature ≥80° C. to ≤140° C.

In another preferred embodiment of the presently claimed invention, a process for coating a substrate is provided comprising the steps of:

applying a coating layer over at least a portion of the substrate, the coating layer comprising:
(A) (a) at least active hydrogen film-forming resin; and
   (b) at least one crosslinker selected from the group consisting of melamine and blocked polyisocyanates;
(B) at least one blocked sulfonic acid; and
(C) at least one polycarbodiimide; and

curing the applied coating layer at a temperature ≥80° C. to ≤110° C.

For the purposes of the presently claimed invention, the aqueous basecoat composition can preferably be applied to the substrate by any of the customary application methods.

Representative examples of the application methods include, but are not limited to, spraying, knife coating, spreading, pouring dipping, impregnating, trickling or rolling. With respect to such application, the substrate to be coated may itself be at rest, with the application unit or equipment being moved. Alternatively, the substrate to be coated, more particularly a coil, may be moved, with the application unit being at rest relative to the substrate or being moved appropriately. Preferable application methods are air spraying, airless spraying, high speed rotation, electrostatic spray application, alone or in conjunction with hot spray application such as hot air spraying, for example.

A basecoat composition is used as a colour-imparting intermediate that is used in automotive finishing and general industrial painting. This basecoat composition is generally applied to a metallic substrate which has been pre-treated with a baked (fully cured) primer-surfacer. Substrates used may also include existing paint systems, which may optionally require pre-treatment as well (by abrading, for example). To protect a basecoat film from environmental effects in particular, at least one additional clearcoat film is generally applied over it. This is generally done in a wet-on-wet process—that is, the clearcoat composition is applied without the basecoat film being cured. Curing then takes place, finally, together with the clearcoat.

The curing of the basecoat-coated substrate and the clearcoat-coated substrate of the presently claimed invention may preferably take place after a certain rest time. The rest time serves, for example, for the levelling and degassing of the coating films or for the evaporation of volatile constituents such as solvents. The rest time may be assisted and/or shortened through the application of elevated temperatures and/or through a reduced atmospheric humidity, if this does not entail any instances of damage to or change in the coating films, such as a premature complete crosslinking.

The thermal curing of the coating materials has no peculiarities in terms of method, but instead takes place in accordance with the customary and known methods, such as heating in a forced air oven or irradiation with IR lamps. This thermal curing may also take place in stages. Another preferred curing method is that of curing with near infrared (NIR radiation).

The curing preferably takes place advantageously at lower temperatures from ≥80° C. to ≤140° C., more preferably from ≥80° C. to ≤110° C., and enables protection of heat sensitive components of automotive parts.

For the purposes of the presently claimed invention, the process of coating a substrate with a basecoat and a clearcoat includes at least the steps of applying the aqueous basecoat of the presently claimed invention to the substrate. Subsequently, the substrate is first dried, i.e. in an evaporation phase, at least some of the organic solvent and/or of the water is removed from the basecoat film. Drying takes place preferably at temperatures from room temperature to 80° C. After drying has taken place, a clearcoat composition is applied. Suitable clearcoat compositions are described in, for example, U.S. Pat. Nos. 8,808, 805, 9, 206,330 B2, US 2015/0210886 A1 and WO 2009/086029 A1. The two-coat finish is subsequently baked, preferably under conditions employed in automotive OEM finishing, at temperatures from 80° C. to 140° C.

In another aspect, the presently claimed invention is directed to a use of an aqueous basecoat composition described hereinabove and hereinbelow in automotive finishing, industrial coating, repair coating, paint and wood coating. For the purposes of the presently claimed invention, the aqueous basecoat composition described hereinabove and hereinbelow can be used in several applications that include but are not limited to automotive OEM finishing, the finishing of parts for installation in or on automobiles and/or utility vehicles, automotive refinish, repair coating, paint, wood coating, and furniture coating.

In yet another aspect, the presently claimed invention is directed to an article which is coated with an aqueous basecoat composition described hereinabove and hereinbelow.

The aqueous basecoat composition of the presently claimed invention are outstandingly suitable as decorative, protective and/or effect coatings and finishes on bodywork of means of transport (especially powered vehicles, such as cycles, motorcycles, buses, trucks or cars) or of parts thereof; on the interior and exterior of edifices; on furniture, windows and doors; on plastics moldings, especially CDs and windows; on small industrial parts, on coils, containers and packaging; on white goods; on films; on optical, electrical and mechanical components; and also on hollow glassware and articles of everyday use, wood coating, and furniture coating.

The aqueous basecoat composition of the presently claimed invention can therefore be applied, for example, to an uncoated or precoated substrate, the coating composition of the presently claimed invention being either pigmented or unpigmented. The aqueous basecoat compositions of the presently claimed invention can be employed in the technologically and aesthetically particularly demanding field of automotive OEM finishing and for the coating of plastics parts for installation in or on car bodies, more particularly for top-class car bodies, such as, for example, for producing roofs, hatches, hoods, fenders, bumpers, spoilers, sills, protective strips, side trim and the like, and for the finishing of commercial vehicles, such as, for example, of trucks, chain-driven construction vehicles, such as crane vehicles, wheel loaders and concrete mixers, buses, rail vehicles, watercraft, aircraft, and also agricultural equipment such as tractors and combines, and parts thereof. Representative examples of plastic material include but are not limited to polyethylene, polypropylene, oriented polypropylene, polyvinyl chloride, polystyrene, polyamides. The aqueous basecoat composition of the presently claimed invention can also be used for automotive refinishing, with automotive refinishing encompassing not only the repair of the OEM finish on the line but also the repair of local defects, such as scratches, stone chip damage and the like, for example, and also complete recoating in corresponding repair workshops and car paint shops for the value enhancement of vehicles.

With particular preference, the aqueous basecoat compositions of the presently claimed invention can be used in multistage coating processes. The presently claimed invention accordingly also provides multicoat colour and/or effect finishes comprising the aqueous basecoat composition.

### EMBODIMENTS

In the following, there is provided a list of embodiments to further illustrate the present disclosure without intending to limit the disclosure to the specific embodiments listed below.

1. An aqueous basecoat composition comprising:
(A) (i) at least one active hydrogen containing film-forming resin; and
   (ii) at least one crosslinker selected from the group consisting of aminoplast resins and blocked polyisocyanates;
(B) at least one acid curing catalyst; and
(C) at least one polycarbodiimide.
   2. The aqueous basecoat composition according to embodiment 1, wherein the at least one active hydrogen containing film-forming resin is selected from the group consisting of polyurethane, polyacrylate, polyester-polyurethane hybrid polymers, polyurethane-polyacrylate hybrid polymers, polyester-polyurethane-polyacrylate hybrid polymers, polyesters, polyethers, polyester polyols and polysiloxane.
   3. The aqueous basecoat composition according to embodiments 1 or 2, wherein the at least one active hydrogen containing film-forming resin is selected from the group consisting of polyesters, polyethers, polyester-polyurethane hybrid polymers, polyurethane -polyacrylate hybrid polymers, and polyester-polyurethane-polyacrylate hybrid polymers.
   4. The aqueous basecoat composition according to embodiments 1 to 3, wherein the at least one active hydrogen film-forming resin has a weight average molecular weight in the range of ≥30,000 g/mol to ≤50,000 g/mol determined according to gel permeation chromatography against a polystyrene standard.
   5. The aqueous basecoat composition according to embodiments 1 to 4, wherein the at least one active hydrogen film-forming resin has an acid value in the range of ≥5 mg KOH/g to ≤100 mg KOH/g, determined according to ASTM D4662.
   6. The aqueous basecoat composition according to embodiments 1 to 5, wherein the at least one active hydrogen film-forming resin is present in an amount in the range of ≥10 wt. % to ≤40 wt. %, based on the total weight of the aqueous basecoat composition.
   7. The aqueous basecoat composition according to embodiment 1, wherein the aminoplast resin is a melamine resin.
   8. The aqueous basecoat composition according to embodiment 1, wherein the at least one crosslinker is present in an amount in the range of ≥5 wt. % to ≤45 wt. %, based on the total weight of the aqueous basecoat composition.
   9. The aqueous basecoat composition according to embodiment 1, wherein the at least one acid curing catalyst comprises a strong acid having a pKa value of ≤1.5 in water at 25° C.
   10. The aqueous basecoat composition according to embodiment 9, wherein the strong acid has a pKa value of ≤1.0 . . . in water at 25° C.
   11. The aqueous basecoat composition according to embodiments 9 or 10, wherein the strong acid having a pKa value of ≤1.5 in water at 25° C. is selected from the group consisting of organic acids.
   12. The aqueous basecoat composition according to embodiment 11, wherein the organic acid is a sulfonic acid or a phosphonic acid.
   13. The aqueous basecoat composition according to embodiment 12, wherein the sulfonic acid is selected from the group consisting of p-toluenesulfonic acid, benzenesulfonic acid, methanesulfonic acid, dodecylbenzenesulfonic acid, dinonylnaphthalene sulfonic acid and dinonylnaphthalene disulfonic acid.
   14. The aqueous basecoat composition according to embodiment 12, wherein the phos-phonic acid is selected from the group consisting of butyl acid phosphate, phenyl acid phosphate and 2-ethylhexyl acid phosphate.
   15. The aqueous basecoat composition according to embodiment 10, wherein the strong acid having a pKa value of ≤1.5 in water at 25° C. is blocked with at least one amine.
   16. The aqueous basecoat composition according to embodiment 15, wherein the at least one amine is selected from the group consisting of aminomethyl propanol, dimethyl ox-azolidine, diisopropanolamine, dimethylethanolamine, pyridine, triethylamine, dimethyl-amino methyl propanol, dimethyloxazolidine, aminomethylpropanol and diisopropanola-mine.
   17. The aqueous basecoat composition according to embodiment 1, wherein the at least one acid curing catalyst is a blocked sulfonic acid.
   18. The aqueous basecoat composition according to embodiments 1 to 10, wherein the at least one acid curing catalyst is present in an amount in the range of ≥0.1 wt. % to ≤5 wt. %, based on the total weight of the aqueous basecoat composition.
   19. The aqueous basecoat composition according to embodiment 1, wherein the at least one polycarbodiimide has a carbodiimide equivalent weight in the range of ≥100 g/mol to ≤600 g/mol.
   20. The aqueous basecoat composition according to embodiment 19, wherein the at least one polycarbodiimide has a carbodiimide equivalent weight in the range of ≥250 g/mol to ≤450 g/mol.
   21. The aqueous basecoat composition according to any of embodiments 1 to 20, wherein the at least one polycarbodiimide is present in an amount in the range of ≥0.1 wt. % to ≤10 wt. %, based on the total weight of the aqueous basecoat composition.
   22. The aqueous basecoat composition according to embodiment 1, further comprising additives selected from the group consisting of solvents, fillers, binders, wetting agent, UV-stabilizers, antioxidants, flow agents, rheology control agent and light stabilizers.
   23. The aqueous basecoat composition according to embodiment 22, wherein the additives are present in an amount in the range of ≥0.1 wt. % to ≤10 wt. %, based on the total weight of the aqueous basecoat composition.
   24. The aqueous basecoat composition according to embodiment 1, further comprising at least one amine in free form.
   25. The aqueous basecoat composition according to embodiment 24, wherein the amine in free form is selected from the group consisting of alkylamines, alkanolamines and ammonia.
   26. The aqueous basecoat composition according to embodiment 24 or 25, wherein the amine in the free form is present in an amount in the range of ≥0.01 wt. % to ≤10 wt. %, based on the total weight of the aqueous basecoat composition.
   27. The aqueous basecoat composition according to any of embodiments 1 to 26, wherein the molar ratio of the at least one amine and at least one amine in free form to the at least one active hydrogen film-forming resin is in the range of 1.5:1 ≥ to ≤3.5:1.
   28. The aqueous basecoat composition according to any of embodiments 1 to 27, further comprising at least one pigment.
   29. The aqueous basecoat composition according to embodiment 28, wherein at least one pigment is selected from the group consisting of organic pigments and metallic pigments.
   30. A multicoat paint system comprising the aqueous basecoat composition according to any of embodiments 1 to 29.
   31. A process for coating a substrate comprising the steps of:
(i) applying a coating layer over at least a portion of the substrate, the coating layer comprising:
   (A) (a) at least active hydrogen film-forming resin; and
      (b) at least one crosslinker selected from the group consisting of aminoplast resins and blocked polyisocyanates;
   (B) at least one acid curing catalyst; and
   (C) at least one polycarbodiimide; and
(ii) curing the applied coating layer at a temperature ≥80° C. to ≤140° C.
   32. The process for coating a substrate according to embodiment 31, wherein the applied coating layer is cured at a temperature ≥80° C. to ≤110° C.
   33. Use of an aqueous basecoat composition according to any of the embodiments 1 to 29 in automotive finishing, industrial coating, repair coating, paint and wood coating.
   34. An article which is coated with an aqueous basecoat composition according to any of the embodiments 1 to 29.

While the presently claimed invention has been described in terms of its specific embodiments, certain modifications and equivalents will be apparent to those skilled in the art and are intended to be included within the scope of the presently claimed invention

### EXAMPLES

The presently claimed invention is illustrated in detail by non-restrictive working examples which follow. More particularly, the test methods specified hereinafter are part of the general disclosure of the application and are not restricted to the specific working examples.

Table 1 provides the basecoat compositions that were prepared and applied to the substrate.

TABLE 1
Basecoat composition

| Basecoat | | | | | | |
|---|---|---|---|---|---|---|
| Component | Example 1* | Example 2* | Example 3* | Example 4 | Example 5 | Example 6 |
| Black | 100 wt. % | 98.04 wt. % | 98.04 wt. % | 96.14 wt. % | 96 wt. % | 95.27 wt. % |
| waterborne | | | | | | |
| basecoat | | | | | | |
| (standard) | | | | | | |
| Polycarbodiimide | — | — | 1.96 wt. % | 1.93 wt. % | 2 wt. % | 1.99 wt. % |
| Blocked para- | — | 1.96 wt. % | — | 1.93 wt. % | 2 wt. % | 1.99 wt. % |
| toluenesulfonic | | | | | | |
| acid (pTSA) | | | | | | |
| 2-amino-2- | — | — | — | — | — | 0.75 wt. % |
| methyl-1- | | | | | | |
| propanol | | | | | | |

*not within the scope of the invention

Polycarbodiimide with a carbodiimide equivalent weight of 350 g/mol was obtained from Stahl Polymers.

Blocked para-toluenesulfonic acid blocked with 4,4-dimethyloxazolidine was obtained from King Industries.

2- amino-2-methyl-1-propanol was obtained from Angus chemical.

Table 2 provides the composition of the black waterborne basecoat (standard) composition used as described in Table 1.

TABLE 2
Black waterborne basecoat (standard) composition

| Component | Weight % | Source |
|---|---|---|
| 3.5% laponite solution in water | 13.271 | BYK |
| de-ionized water | 19.239 | |
| waterborne polyurethane resin (42% solids) | 12.871 | BASF |
| Resimene ® HM-2608 (high-imino, | 5.624 | INEOS |
| methylated type melamine) | | Melamines |
| anionic waterborne polyurethane resin (27% | 15.623 | BASF |
| solids) | | |
| waterborne polyurethane-acrylic hybrid resin | 2.412 | BASF |
| (36% solids) | | |
| black tint paste (9% carbon black pigment; | 15.422 | BASF |
| 10% anionic waterborne grind resin) | | |
| BYK ® 345, polyether-modified siloxane | 0.168 | BYK |
| surfactant | | |
| dimethylethanolamine | 0.101 | Huntsman |
| Viscalex ® HV30 (acrylic rheology modifier) | 6.695 | BASF |
| dipropylene glycol n-propyl ether | 2.426 | DOW |
| ethylene glycol monobutyl ether | 1.177 | DOW |
| triisobutyl phosphate | 0.924 | LANXESS |
| mineral spirits (co-solvent) | 0.69 | Shell |
| 2-ethylhexanol (co-solvent) | 1.976 | Eastman |
| propylene glycol polyether diol | 0.471 | BASF |
| tripropylene glycol monomethyl ether | 0.91 | DOW |

TABLE 3
Clearcoat composition

| | Component | Weight % | Source |
|---|---|---|---|
| A | acrylic resin | 91.32 | BASF |
| | BYK ® 320 (silicone flow additive) | 0.09 | BYK |
| | Tinuvin ® 384 (UV absorber) | 2.98 | BASF |
| | Tinuvin ® 123 (hindered amine light | 0.95 | BASF |
| | stabilizer) | | |
| | methyl amyl ketone | 25.34 | Eastman |
| B | Duranate ® MF K-60X (blocked | 28.04 | Asahi Kasei |
| | Isocyanate) | | |
| | Resimene ® HM2608 (high-imino, | 12.46 | Ineos |
| | methylated type melamine)) | | Melamines |
| | BYK ® 320 (silicone flow additive) | 0.03 | BYK |
| C | 35% pTSA in n-butyl alcohol | 8.96 | BASF |

Preparation of the coated substrates

Preparation of OEM panels

Cold rolled steel test panels measuring 4″×12″ were used as a substrate. The panels were pretreated with Bondrite® 958 zinc phosphate pretreatment and rinsed with Parcolene® 90 post-rinse, both available from Henkel. The panels were electrocoated with a 0.7-0.8 mil layer of BASF Cathoguard® 800 electrocoat and baked for 20 minutes at (350° F.) 176.7° C. The panels were sprayed with 0.6-0.8 mil layer of BASF U338AU225F gray primer in one coat, given a five-minute ambient flash, and then flashed for 5 minutes at (140° F.) 60° C. The panels were then coated with a 0.5-0.6 mil layer of the OEM black waterborne basecoat described herein above, which was applied to the panel in two coats. After coating with the basecoat, the panels received a 5-minute ambient flash and a 5-minute heated flash at (140° F.) 60° C. Subsequently 1.8-2.0 mils of BASF E1OCG081G solventborne, 2-compoinent clearcoat was applied to the panel in two coats. After the clearcoat was applied the panels received a 10-minute ambient flash and a 25-minute bake at a temperature of (265° F.) 129.4° C.

Preparation of low bake repair panels

The cured OEM panels were aged for 24 hours and then fully de-glossed by hand sanding with 800-grit sandpaper. The sanded OEM panels were cleaned with an isopropanol wipe to prepare for spraying a repair layer. The same sample of OEM black waterborne basecoat described herein above used for preparing the OEM panels was modified as shown in Table 1. The modified basecoats were applied to the sanded OEM panels at a thickness of 0.3-0.4 mils in one coat. After coating with the modified basecoats, the panels received a 5-minute ambient flash and a 5-minute heated flash at (176° F.)80° C. Subsequently 1.3-1.5 mils of low bake spot repair clearcoat described herein above was applied to the panel in one coat. After the clearcoat was applied the panels received a 10-minute ambient flash and a 15-minute bake. Baking temperatures of both (190° F.) 87.8° C. and (210° F.) 98.9° C. were used. The cured low bake repair panels were aged for 72 hours before evaluating for for Xylene double rubs, Konig hardness, Tukon hardness, initial and post humidity adhesion as shown in Table 4 be-low.

TABLE 4
Evaluation of adhesion and hardness

| Parameter | Example 1* | Example 2* | Example 3* | Example 4 | Example 5 | Example 6 |
|---|---|---|---|---|---|---|
| Konig pendulum | 24 | 27 | 31 | 52 | 38 | 36 |
| hardness | | | | | | |
| Tukon hardness | <0.5 | <0.5 | 1.4 | 5.7 | — | — |
| (Knoops) | | | | | | |
| 10 Xylene double | Rub | Rub | No Rub | No Rub | — | — |
| rubs | Marks | Marks | Marks | Marks | | |
| Initial adhesion | 1 | 1 | 1 | 1 | 1 | 2 |
| Post-QCT adhesion | 8 | 6 | 2 | 2 | 7 | 1 |
| Post-QCT blisters | Yes | Yes | No | No | — | — |

*Not within the scope of the invention

Discussion of results

Table 4 shows the physical properties determined for different samples that were prepared according to process described hereinabove. The addition of both the polycarbodiimide resin and the blocked pTSA catalyst provides improved hardness and adhesion as shown in Table 4.

Table 4 shows the most significant impact in the physical properties because of the synergistic effect and super-additive effect when the polycarbodiimide and the acid catalyst are both added to the basecoat composition. Addition of the polycarbodiimide resin alone gives improved xylene resistance, adhesion, and blistering performance. Addition of the acid catalyst alone gives slight improvement in adhesion and hardness. But when polycarbodiimide and the acid catalyst are added together, the composition provides improved adhesion and significantly improved hardness, which cannot be achieved without the combination of both the resin and the acid catalyst. The addition of a neutralizing agent like an amine or a blocking agent or the acid catalyst to the basecoat provides improved performance of the coating. The addition of a neutralizing agent like an amine along with the carbodiimide and blocked acid provides improvement in post-QCT or post-humidity adhesion as shown in Example 6.

The basecoat compositions of the examples according to the presently claimed invention show improved performance in terms of hardness, polishability and adhesion even at low curing temperatures as shown hereinabove.

Test Methods

Polymer Molecular Weight Determination

To determine polymer molecular weights by gel permeation chromatography (GPC), fully dissolved molecules of a polymer sample were fractionated on a porous column stationary phase. Tetrahydrofuran (THE) was used as the eluent solvent. The molecular weight distribution, the number average molecular weight Mn and the mass average molecular weight Mw and the polydispersity Mw/Mn of the polymer samples were calculated with the aid of chromatography software utilizing a calibration curve generated with the EasyValid validation kit which includes a series of unbranched-polystyrene standards of varied molecular weights available from Polymer Standards Service.

Equivalent Weight Determination

The equivalent weight was determined in accordance with the Standard Test Method ASTM D1652.

Solid Content Determination

The solid content was determined in accordance with the Standard Test Method ASTM D2369.

Acid Number Determination

The acid number was determined in accordance with the Standard Test Method ASTM D3643.

Konig Hardness determination

The Konig hardness was determined using the Konig pendulum hardness tester in accordance with the Standard Test Method ASTM D4366.

Xylene Double Rubs Determination

The xylene double rubs were determined according to the following procedure. A 2″×2″ square of cheesecloth (VWR Cat No. 21910-107) was folded into a 1″ by 1″ square and dipped into a container of xylene. The cheesecloth was removed and applied to a coated substrate with the thumb. With moderate pressure, the cheesecloth was rubbed for a length of 4 inches in the outward direction and then back across the same path. This constituted one “double rub.” This procedure was repeated for a total of 10 double rubs.

After the ten double rubs were complete, the residual solvent was allowed to evaporate from the panel. The panel was then visibly inspected to see if there were any scratches or removal of film.

Ford adhesion (with Condensing Humidity) determination:

The Ford adhesion was determined in accordance with the Standard Test Method FLTM BI 106-01.

Panels were aged for 72 hours before adhesion is tested. Adhesion was conducted in two separate areas on the panel. Initially: After 240 h of test environment (30 minutes is allowed after removal from humidity chamber before adhesion test). The test environment is Standard Test Method ASTM D4585. The temperature used for the condensing humidity was 43.33° C. (110° F.). Additionally, panels were visually inspected to see if there are any permanent blisters. If blisters are present, observation of blisters is recorded.

Tukon Hardness Determination

To evaluate the Tukon hardness or microhardness of a coated substrate a Wolpert Wilson Tukon 2100 was utilized. A coated substrate was placed upon the stage of the instrument below the Tukon indenter. The indenter uses a pyramid-shaped diamond tip which applies a 25 g load to the surface of the coated substrate for 18±0.5 seconds. The instrument also has a microscope with a filar micrometer eyepiece. After the indentation was complete, the microscope was used to measure the length of the impression. The instrument calculates the Knoop hardness number (KHN) from the following equation:

$$KHN = \frac{0.025}{{L}^{( 2 ) *} {C}_{p}}$$

### Where:

0.025=load applled. kg, to the indenter
L=length of long dtagonal of indentation, mm. and
Cₚ=indenter constant=7.028×10⁽²⁾

1. An aqueous basecoat composition comprising:
(A) (i) at least one active hydrogen containing film-forming resin; and
(ii) at least one crosslinker selected from the group consisting of aminoplast resins and blocked polyisocyanates;
(B) at least one acid curing catalyst; and
(C) at least one polycarbodiimide.

2. The aqueous basecoat composition according to claim 1, wherein the at least one active hydrogen containing film-forming resin is selected from the group consisting of polyurethane, polyacrylate, polyester-polyurethane hybrid polymers, polyurethane-polyacrylate hybrid polymers, polyester-polyurethane-polyacrylate hybrid polymers, polyesters, polyethers, polyester polyols and polysiloxane.

3. The aqueous basecoat composition according to claim 1, wherein the at least one active hydrogen film-forming resin has a weight average molecular weight in the range of ≥30,000 g/mol to ≤50,000 g/mol determined according to gel permeation chromatography against a polystyrene standard.

4. The aqueous basecoat composition according to claim 1, wherein the aminoplast resin is a melamine resin.

5. The aqueous basecoat composition according to claim 1, wherein the at least one acid curing catalyst comprises a strong acid having a pKa value of ≤1.5 in water at 25° C.

6. The aqueous basecoat composition according to claim 5, wherein the strong acid having a pKa value of ≤1.5 in water at 25° C. is selected from the group consisting of organic acids.

7. The aqueous basecoat composition according to claim 6, wherein the organic acid having a pKa value of ≤1.5 in water at 25° C. is a sulfonic acid or a phosphonic acid.

8. The aqueous basecoat composition according to claim 5, wherein the strong acid having a pKa value of ≤1.5 in water at 25° C. is blocked with at least one amine.

9. The aqueous basecoat composition according to claim 1, wherein the at least one polycarbodiimide has a carbodiimide equivalent weight in the range of ≥100 g/mol to ≤600 g/mol.

10. The aqueous basecoat composition according to claim 1, further comprising at least one pigment.

11. A multicoat paint system comprising the aqueous basecoat composition according to claim 1.

12. A process for coating a substrate comprising the steps of:
(i) applying a coating layer over at least a portion of the substrate, the coating layer comprising:
(A) (a) at least active hydrogen film-forming resin; and
(b) at least one crosslinker selected from the group consisting of aminoplast resins and blocked polyisocyanates;
(B) at least one acid curing catalyst; and
(C) at least one polycarbodiimide; and
(ii) curing the applied coating layer at a temperature ≥80° C. to ≤140° C.

13. The process for coating a substrate according to claim 12, wherein the applied coating layer is cured at a temperature ≥80° C. to ≤110° C.

14. A method of using the aqueous basecoat composition according to claim 1, the method comprising using the aqueous basecoat composition in automotive finishing, industrial coating, repair coating, paint or wood coating.

15. An article which is coated with an aqueous basecoat composition according to claim 1.
